(19) United States
(12) Patent Application Publication
(10) Pub. No.: US 2022/0178265 A1
(43) Pub. Date: Jun. 9, 2022

(54) FLUID FLOW GUIDING DEVICE AND A GAS TURBINE ENGINE

(71) Applicant: Rolls-Royce Deutschland Ltd & Co KG, Blankenfelde-Mahlow (DE)

(72) Inventor: Christoph KLAUS, Teltow (DE)

(21) Appl. No.: 17/544,063

(22) Filed: Dec. 7, 2021

(30) Foreign Application Priority Data
Dec. 9, 2020 (DE) 10 2020 215 576.3

(51) Int. Cl. F01D 9/02; F02K 3/02

(52) U.S. Cl. CPC F01D 9/02; F05D 2220/323; F02K 3/02

(57) ABSTRACT

The invention concerns a flow guide device for a gas turbine engine, in particular an aircraft engine, with a fan and a bypass duct downstream of the fan, wherein the bypass duct is arranged radially between an engine nacelle and a core engine of the gas turbine engine, characterized by a guide vane assembly with load-bearing guide vanes and additional guide vanes in the bypass duct, wherein the load-bearing guide vanes are integrally connected to a structural component of the gas turbine engine, and the additional guide vanes are connected to the structural component via connecting means. The invention furthermore concerns a gas turbine device.

This application claims priority to German Patent Application DE102020215576.3 filed Dec. 9, 2020, the entirety of which is incorporated by reference herein.

The present disclosure relates to a flow guide device having the features of claim 1 and to a gas turbine device having the features of claim 15.

In a turbofan engine of an aircraft, a fan uses the mechanical energy of a turbine to accelerate inflowing air downstream and hence generate the majority of the thrust. This thrust is achieved by the bypass air flow.

The rotational movement of the fan causes turbulence in the air in the bypass air flow during reverse acceleration. In order to maximize the efficiency of the engine thrust, the air must be deflected again and directed onto the engine axis.

This is usually achieved by an outlet guide vane (OGV) arranged behind the fan with an appropriate wing profile form and inclination. In any case, a certain number of guide vanes are required which are distributed around the circumference in order to align the air flow behind the fan. This can be achieved either by the provision of a separate level of guide vanes behind the fan, or by integrating the guide vanes in an engine front structure which is typically part of the aircraft engine.

In principle, the efficiency of the aircraft engine is proportional to the number of guide vanes for aligning the flow. However, mechanical loads acting on the guide vanes because of the flow deflection must also be tolerated by the connected parts of the aircraft engine.

Typically, the parts concerned are produced by a casting process which limits the number of guide vanes with complex form.

It is therefore necessary to provide corresponding guide vane devices which increase the efficiency of the aircraft engine.

For this, a flow guide device is arranged in a bypass duct downstream of a fan, wherein a guide vane assembly comprises load-bearing guide vanes and additional guide vanes. The load-bearing guide vanes are integrally connected to a structural component of the gas turbine engine, as is the case with conventionally used cast components.

The additional guide vanes are however connected to the structural component via connecting means, i.e. are integrally connected to the structural component. So it is possible to use more than the relatively few load-bearing guide vanes, so that rotation of the flow in the bypass duct can be efficiently influenced. In principle, it is also possible to select the shape and/or size of the additional guide vanes independently of those of the load-bearing guide vanes.

In one embodiment, the structural component is connected or coupled to a part of the core engine and/or to a part of the engine nacelle.

The connecting means between the additional guide vanes and the structural component may be configured as screw connections, form-fit connections, and/or substance-bonded connections. In the former two cases, the additional guide vanes can easily be replaced during maintenance if necessary.

In one embodiment, the number of additional guide vanes is equal to or greater than the number of load-bearing guide vanes. In particular, the ratio of the number of additional guide vanes to load-bearing guide vanes is between 1:2 and 10:1, in particular between 1:1 and 10:1. These ratios mean that it is quite possible for there to be more load-bearing guide vanes than additional guide vanes.

Also, in operation, the additional guide vanes bear a smaller structural load than the load-bearing guide vanes.

Here, the additional guide vanes may have the same aerodynamically active profile and/or the same size as the load-bearing guide vanes. It is however also possible that the additional guide vanes have a different aerodynamically active profile and/or a different size from the load-bearing guide vanes. It is also possible that the additional guide vanes are formed differently from one another, e.g. have different angles of attack or cross-sectional geometries.

To reduce the wear phenomena, the leading edge and/or the trailing edge of the additional guide vanes and/or the load-bearing vanes may be provided with a metal coating.

Since air flows dynamically onto the additional guide vanes and the gas turbine engine is also a source of numerous mechanical excitations, in one embodiment the additional guide vanes may be connected to a mechanical damping element, in particular made of elastic plastic.

The additional guide vanes may here be made of a composite material, in particular a carbon-fiber composite material, or a metallic material.

In one embodiment, the connecting means of the additional guide vanes may comprise a bolted connection.

Also, the additional guide vanes may be connected to an intermediate casing structure. In particular, the intermediate casing structure may comprise two concentrically arranged rings.

The object is also achieved by a gas turbine engine having the features of claim 15.

It is also possible to provide a gas turbine engine with an embodiment of an intermediate casing structure.

As noted elsewhere herein, the present disclosure may relate to a gas turbine engine, for example an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be advantageous in particular, but not exclusively, for geared fans, which are driven via a gear mechanism. Accordingly, the gas turbine engine may comprise a gear mechanism which is driven via the core shaft and the output of which drives the fan in such a way that it has a lower rotational speed than the core shaft. The input to the gear mechanism may be effected directly from the core shaft, or indirectly via the core shaft, for example via a spur shaft and/or a spur gear. The core shaft may be rigidly connected to the turbine and the compressor, such that the turbine and compressor rotate at the same rotational speed (with the fan rotating at a lower rotational speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may furthermore comprise a second turbine, a second compressor, and a second core shaft connecting the second turbine to the second compressor. The second turbine, second compressor and second core shaft may be arranged so as to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gear mechanism may be designed to be driven by the core shaft that is configured to rotate (for example during use) at the lowest rotational speed (for example the first core shaft in the example above). For example, the gear mechanism may be designed to be driven only by the core shaft that is configured to rotate (for example during use) at the lowest rotational speed (for example only by the first core shaft and not the second core shaft, in the example above). Alternatively, the gear mechanism may be designed to be driven by one or more shafts, for example the first and/or second shaft in the example above.

In a gas turbine engine as described and/or claimed herein, a combustor may be provided axially downstream of the fan and compressor (or compressors). For example, the combustor may be directly downstream of (for example at the exit of) the second compressor, when a second compressor is provided. By way of further example, the flow at the exit of the compressor may be supplied to the inlet of the second turbine, if a second turbine is provided. The combustor may be provided upstream of the turbine(s).

The or each compressor (for example the first compressor and the second compressor as described above) may comprise any number of stages, for example multiple stages. Each stage may comprise a row of rotor blades and a row of stator blades, which may be variable stator blades (i.e. the angle of attack may be variable). The row of rotor blades and the row of stator blades may be axially offset with respect to one another.

The or each turbine (for example the first turbine and the second turbine as described above) may comprise any number of stages, for example multiple stages. Each stage may comprise a row of rotor blades and a row of stator blades (guide vanes). The row of rotor blades and the row of stator blades may be axially offset with respect to one another.

Each fan blade may have a radial span extending from a root (or a hub) at a radially inner location over which gas flows, or from a position of 0% span, to a tip with a 100% span. The ratio of the radius of the fan blade at the hub to the radius of the fan blade at the tip may be less than (or of the order of) any of the following: 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range bounded by any two values in the previous sentence (i.e. the values may form the upper or lower bounds). These ratios may be referred to in general as the hub-to-tip ratio. The radius at the hub and the radius at the tip may both be measured at the leading edge (or the axially forwardmost edge) of the blade. The hub-to-tip ratio refers, of course, to that portion of the fan blade over which gas flows, i.e. the portion radially outside any platform.

The radius of the fan may be measured between the engine centerline and the tip of the fan blade at its leading edge. The diameter of the fan (which can generally be double the radius of the fan) may be larger than (or of the order of): 250 cm (approximately 100 inches), 260 cm (approximately 102 inches), 270 cm (approximately 105 inches), 280 cm (approximately 110 inches), 290 cm (approximately 115 inches), 300 cm (approximately 120 inches), 310 cm (approximately 122 inches), 320 cm (approximately 125 inches), 330 cm (approximately 130 inches), 340 cm (approximately 135 inches), 350 cm (approximately 138 inches), 360 cm (approximately 140 inches), 370 cm (approximately 145 inches), 380 cm (approximately 150 inches) or 390 cm (approximately 155 inches). The fan diameter may be in an inclusive range bounded by any two of the values in the previous sentence (i.e. the values may form the upper or lower bounds).

The rotational speed of the fan may vary in operation. Generally, the rotational speed is lower for fans with a larger diameter. Purely as a non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range of from 250 cm to 300 cm (for example 250 cm to 280 cm) may be in the range from 1700 rpm to 2500 rpm, for example in the range from 1800 rpm to 2300 rpm, for example in the range of from 1900 rpm to 2100 rpm. Purely by way of a further non-limiting example, the rotational speed of the fan under cruise conditions for an engine having a fan diameter in the range of from 320 cm to 380 cm may be in the range from 1200 rpm to 2000 rpm, for example in the range from 1300 rpm to 1800 rpm, for example in the range from 1400 rpm to 1600 rpm.

During the use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH of the flow. A fan tip loading may be defined as dH/Uₜᵢₚ², where dH is the enthalpy rise (for example the average 1-D enthalpy rise) across the fan and Uₜᵢₚ is the (translational) speed of the fan tip, for example at the leading edge of the tip (which may be defined as fan tip radius at the leading edge multiplied by angular speed). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure can have any desired bypass ratio, wherein the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form the upper or lower bounds). The bypass duct may be substantially annular. The bypass duct may be radially outside the core engine. The radially outer surface of the bypass duct may be defined by an engine nacelle and/or a fan casing.

The overall pressure ratio of a gas turbine engine as described and/or claimed herein may be defined as the ratio of the stagnation pressure upstream of the fan to the stagnation pressure at the exit of the highest pressure compressor (before entry into the combustor). As a non-limiting example, the overall pressure ratio of a gas turbine engine as described and/or claimed herein at cruising speed may be greater than (or of the order of): 35, 40, 45, 50, 55, 60, 65, 70, 75. The overall pressure ratio may be in an inclusive range bounded by any two of the values in the previous sentence (i.e. the values may form the upper or lower bounds).

The specific thrust of an engine can be defined as the net thrust of the engine divided by the total mass flow through the engine. The specific thrust of an engine as described and/or claimed herein at cruise conditions may be less than (or of the order of): 110 N kg⁻¹s, 105 N kg⁻¹s, 100 N kg⁻¹s, 95 N kg⁻¹s, 90 N kg⁻¹s, 85 N kg⁻¹s or 80 N kg⁻¹s. The specific thrust may be in an inclusive range bounded by any two of the values in the previous sentence (i.e. the values may form the upper or lower bounds). Such engines can be particularly efficient in comparison with conventional gas turbine engines.

A gas turbine engine as described and/or claimed herein may have any desired maximum thrust. Purely as a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN or 550 kN. The maximum thrust may be in an inclusive range bounded by any two of the values in the previous sentence (i.e. the values may form the upper or lower bounds). The thrust referred to above may be the maximum net thrust under standard atmospheric conditions at sea level plus 15° C. (ambient pressure 101.3 kPa, temperature 30° C.), with the engine static.

During use, the temperature of the flow at the entry to the high-pressure turbine can be particularly high. This temperature, which may be referred to as TET, may be measured at the exit to the combustor, for example immediately upstream of the first turbine blade, which itself may be referred to as a nozzle guide blade. At cruising speed, the TET may be at least (or of the order of): 1400 K, 1450 K, 1500 K, 1550 K, 1600 K or 1650 K. The TET at cruising speed may be in an inclusive range bounded by any two of the values in the previous sentence (i.e. the values may form the upper or lower bounds). The maximum TET in the use of the engine may be at least (or of the order of), for example: 1700 K, 1750 K, 1800 K, 1850 K, 1900 K, 1950 K or 2000 K. The maximum TET may be in an inclusive range bounded by any two of the values in the previous sentence (i.e. the values may form the upper or lower bounds). The maximum TET may occur, for example, under a high thrust condition, for example under a maximum take-off thrust (MTO) condition.

A fan blade and/or airfoil portion of a fan blade described and/or claimed herein may be produced from any suitable material or combination of materials. For example, at least a part of the fan blade and/or airfoil may be produced at least in part from a composite, for example a metal matrix composite and/or an organic matrix composite, such as carbon fiber. As a further example, at least a part of the fan blade and/or airfoil may be produced at least in part from a metal, such as a titanium-based metal or an aluminum-based material (such as an aluminum-lithium alloy) or a steel-based material. The fan blade may comprise at least two regions produced using different materials. For example, the fan blade may have a protective leading edge, which is produced using a material that is better able to resist impact (for example from birds, ice or other material) than the rest of the blade. Such a leading edge may, for example, be produced using titanium or a titanium-based alloy. Thus, purely by way of example, the fan blade may have a carbon-fiber or aluminum-based body (such as an aluminum-lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture device which may engage with a corresponding slot in the hub (or disk). Purely as an example, such a fixture may be in the form of a dovetail that may slot into and/or be brought into engagement with a corresponding slot in the hub/disk in order to fix the fan blade to the hub/disk. As a further example, the fan blades may be formed integrally with a central portion. Such an arrangement may be referred to as a blisk or a bling. Any suitable method may be used to manufacture such a blisk or such a bling. For example, at least some of the fan blades may be machined from a block and/or at least some of the fan blades may be attached to the hub/disk by welding, such as e.g. linear friction welding.

The gas turbine engines described and/or claimed herein may or may not be provided with a variable area nozzle (VAN). Such a variable area nozzle may allow the exit cross-sectional area of the bypass duct to be varied during operation. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such cruise conditions can be conventionally defined as the conditions at mid-cruise, for example the conditions experienced by the aircraft and/or the engine between (in terms of time and/or distance) the top of climb and the start of descent.

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any speed within these ranges may be the cruise condition. For some aircraft, the cruise condition may be outside these ranges, for example below Mach 0.7 or above Mach 0.9.

Purely as an example, the cruise conditions may correspond to standard atmospheric conditions at an altitude that is in the range of from 10,000 m to 15,000 m, for example in the range of from 10,000 m to 12,000 m, for example in the range of from 10,400 m to 11,600 m (around 38,000 ft), for example in the range of from 10,500 m to 11,500 m, for example in the range of from 10,600 m to 11,400 m, for example in the range of from 10,700 m (around 35,000 ft) to 11,300 m, for example in the range of from 10,800 m to 11,200 m, for example in the range of from 10,900 m to 11,100 m, for example of the order of magnitude of 11,000 m. The cruise conditions may correspond to standard atmospheric conditions at any given altitude in these ranges.

Purely as an example, the cruise conditions may correspond to the following: a forward Mach number of 0.8, a pressure of 23000 Pa and a temperature of −55° C.

As used anywhere herein, “cruising speed” or “cruise conditions” may mean the aerodynamic design point. Such an aerodynamic design point (or ADP) may correspond to the conditions (comprising, for example, the Mach number, environmental conditions and thrust demand) for which the fan is designed to operate. This may mean, for example, the conditions at which the fan (or gas turbine engine) is designed to have optimum efficiency.

During operation, a gas turbine engine described and/or claimed herein may be operated under the cruise conditions defined elsewhere herein. Such cruise conditions may be determined by the cruise conditions (for example the conditions during the middle part of the flight) of an aircraft on which at least one (for example two or four) gas turbine engine(s) may be mounted in order to provide propulsive thrust.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

Embodiments will now be described by way of example, with reference to the figures, in which:

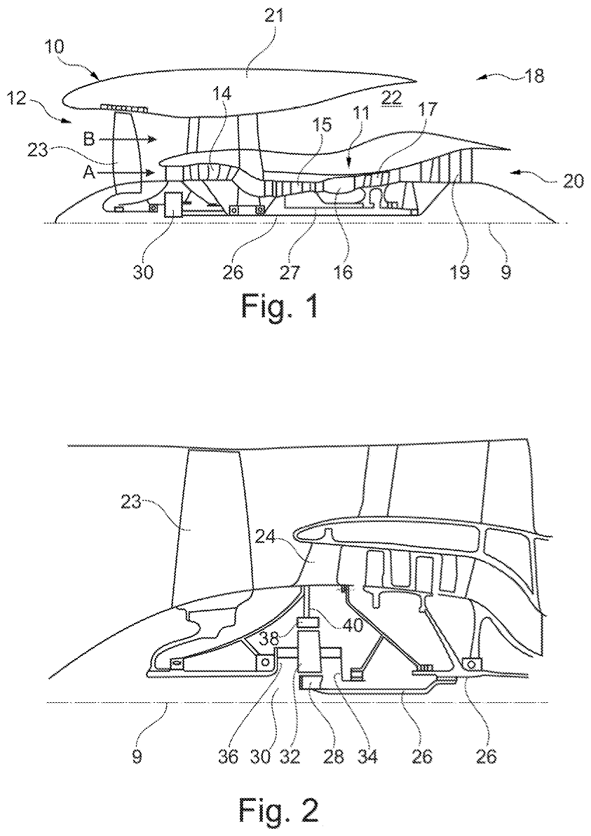

FIG. 1 shows a sectional side view of a gas turbine engine;

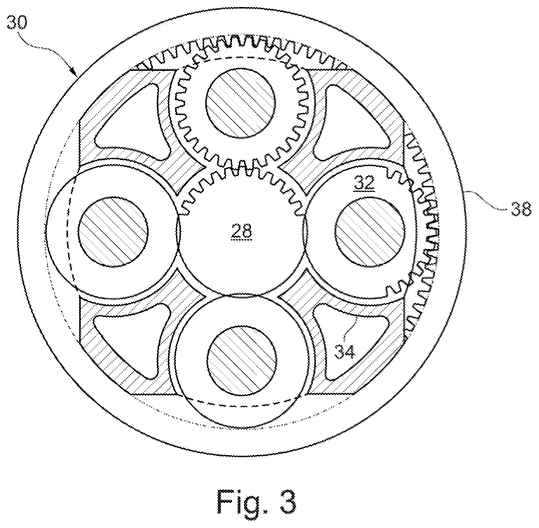

FIG. 2 shows a close-up sectional side view of an upstream portion of a gas turbine engine;

FIG. 3 shows a partially cut-away view of a gear mechanism for a gas turbine engine;

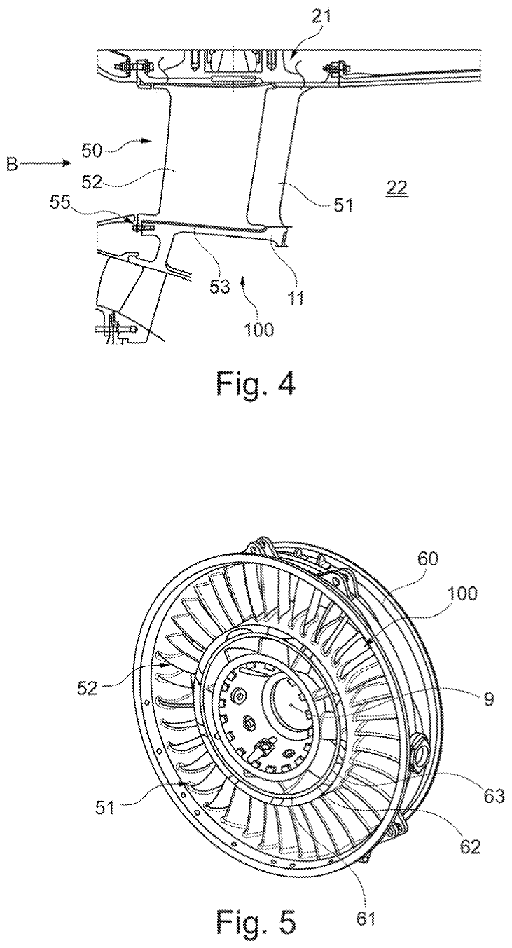

FIG. 4 shows a sectional view through an embodiment of a flow guide device with additional guide vanes;

FIG. 5 shows a perspective view through a further embodiment of a flow guide device with additional guide vanes;

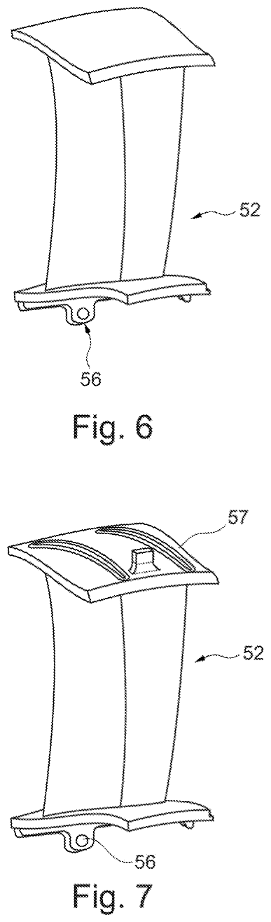

FIG. 6 shows a perspective illustration of an additional guide vane;

FIG. 7 shows a perspective illustration of a further embodiment of an additional guide vane;

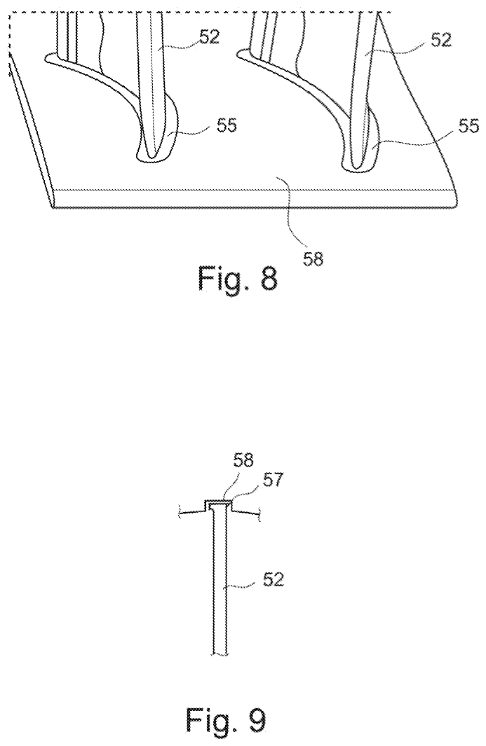

FIG. 8 shows a detail view of a fixing of additional guide vanes;

FIG. 9 shows an example of a form-fit guide of a distal end of an additional guide vane.

FIG. 1 illustrates a gas turbine engine 10 having a main axis of rotation 9. The gas turbine engine 10 comprises an air inlet 12 and a fan 23 that generates two air flows: a core air flow A and a bypass air flow B. The gas turbine engine 10 comprises a core engine 11 that receives the core air flow A. When viewed in the order corresponding to the axial direction of flow, the core engine 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear mechanism 30. The epicyclic planetary gear mechanism 30 is a reduction gear mechanism.

During operation, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before being expelled through the nozzle 20 to provide a certain propulsive thrust. The high-pressure turbine 17 drives the high-pressure compressor 15 by means of a suitable connecting shaft 27. The fan 23 generally provides the major part of the propulsive thrust. For high efficiency of the gas turbine engine, it is important that a rotation in the bypass air flow B is deflected in the direction of the engine axis.

A flow guide device 100, the function of which is described in more detail in connection with FIGS. 4 to 9, is arranged axially at the exit from the engine nacelle 21. In other embodiments, the engine nacelle 21 may extend axially over the region of the low-pressure compressor 14 up to the region of the high-pressure turbine 17.

An exemplary arrangement for a geared fan gas turbine engine 10 is shown in FIG. 2. The low-pressure turbine 19 (see FIG. 1) drives the shaft 26, which is coupled to a sun gear 28 of the epicyclic planetary gear mechanism 30. Multiple planet gears 32, which are coupled to one another by a planet carrier 34, are situated radially to the outside of the sun gear 28 and mesh therewith. The planet carrier 34 guides the planet gears 32 in such a way that they circulate synchronously around the sun gear 28, whilst enabling each planet gear 32 to rotate about its own axis. The planet carrier 34 is coupled via linkages 36 to the fan 23 in order to drive its rotation about the engine axis 9. Radially to the outside of the planet gears 32 and meshing therewith is an annulus or ring gear 38 that is coupled, via linkages 40, to a stationary support structure 24.

It is noted that the terms “low-pressure turbine” and “low-pressure compressor” as used herein may be taken to mean the lowest-pressure turbine stage and lowest-pressure compressor stage (i.e. not including the fan 23) respectively, and/or the turbine and compressor stages that are connected together by the connecting shaft 26 with the lowest rotational speed in the engine (i.e. not including the gearbox output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first, or lowest-pressure, compression stage.

The epicyclic planetary gear mechanism 30 is shown by way of example in greater detail in FIG. 3. The sun gear 28, planet gears 32 and ring gear 38 in each case comprise teeth on their periphery to allow intermeshing with the other gearwheels. However, for clarity, only exemplary portions of the teeth are illustrated in FIG. 3. Although four planet gears 32 are illustrated, it will be apparent to the person skilled in the art that more or fewer planet gears 32 may be provided within the scope of protection of the claimed invention. Practical applications of an epicyclic planetary gear mechanism 30 generally comprise at least three planet gears 32.

The epicyclic planetary gear mechanism 30 illustrated by way of example in FIGS. 2 and 3 is a planetary gear mechanism in which the planet carrier 34 is coupled to an output shaft via linkages 36, with the ring gear 38 being fixed. However, any other suitable type of planetary gear mechanism 30 may be used. As a further example, the planetary gear mechanism 30 may be a star arrangement, in which the planet carrier 34 is held fixed, with the ring gear (or external gear) 38 allowed to rotate. In such an arrangement, the fan 23 is driven by the ring gear 38. As a further alternative example, the gear mechanism 30 can be a differential gear mechanism in which both the ring gear 38 and the planet carrier 34 are allowed to rotate.

It will be appreciated that the arrangement shown in FIGS. 2 and 3 is by way of example only, and various alternatives are within the scope of protection of the present disclosure. Purely by way of example, any suitable arrangement may be used for locating the gear mechanism 30 in the gas turbine engine 10 and/or for connecting the gear mechanism 30 to the gas turbine engine 10. As a further example, the connections (for example the linkages 36, 40 in the example of FIG. 2) between the gear mechanism 30 and other parts of the gas turbine engine 10 (such as the input shaft 26, the output shaft and the fixed structure 24) may have a certain degree of stiffness or flexibility. As a further example, any suitable arrangement of the bearings between rotating and stationary parts of the gas turbine engine 10 (for example between the input and output shafts of the gear mechanism and the fixed structures, such as the gear casing) may be used, and the disclosure is not limited to the exemplary arrangement of FIG. 2. For example, where the gear mechanism 30 has a star arrangement (described above), a person skilled in the art would readily understand that the arrangement of output and supporting linkages and bearing positions would usually be different from that shown by way of example in FIG. 2.

Accordingly, the present disclosure extends to a gas turbine engine having any arrangement of gear mechanism types (for example star or epicyclic-planetary), supporting structures, input and output shaft arrangement, and bearing positions.

Optionally, the gear mechanism may drive additional and/or alternative components (for example the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. By way of a further example, the gas turbine engine shown in FIG. 1 has a split flow nozzle 20, 22, meaning that the flow through the bypass duct 22 has its own nozzle that is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable area. In some arrangements, the gas turbine engine 10 may not comprise a gear mechanism 30.

The geometry of the gas turbine engine 10, and components thereof, is/are defined by a conventional axis system, comprising an axial direction (which is aligned with the axis of rotation 9), a radial direction (in the bottom-to-top direction in FIG. 1), and a circumferential direction (perpendicular to the view in FIG. 1). The axial, radial and circumferential directions run so as to be mutually perpendicular.

On the basis of FIGS. 4 to 9, embodiments of the flow guide device 100 are now described which serve to reduce the rotational part of the bypass air flow B.

FIG. 4 shows an extract from the illustration in FIG. 2 which shows the flow guide device 100 behind the fan 23 (not shown here). The rotating bypass air flow B flows from left to right through the bypass duct 22.

The purpose of a guide vane assembly 50 as part of the flow guide device 100 in the bypass duct 22 is to align the bypass air flow B, flowing in from the left here, such that the rotation in the flow is reduced, ideally even reduced to zero. For this, the guide vane assembly 50 comprises load-bearing guide vanes 51 and additional guide vanes 52, which are illustrated as a whole in FIG. 5.

FIG. 4 shows the load-bearing guide vane 51 behind the additional guide vane 52. The load-bearing guide vane absorbs forces and moments from the bypass air flow B and conducts them in the known fashion to a structural component 60 (see FIG. 5), which is here connected to the core engine 11 and engine nacelle 21. The structural component 60 is a cast component which is integrally connected to the load-bearing guide vanes 51 (see FIG. 5).

The additional guide vanes 52 are not integrally connected to the structural component 60, but via a connecting means 55; in the embodiment illustrated, via a screw connection. The connecting means 55 is here arranged such that it is situated in a cavity and not exposed to the air flow.

Thus the additional guide vanes 52 transfer significantly lower forces and moments to the structural component 60 than the load-bearing guide vanes 51.

To damp vibrations, the additional guide vanes 52 are coupled to a damping means 53, e.g. a rubber part, which is illustrated schematically in FIG. 4.

Since the number of load-bearing guide vanes 51 is limited by the design in the casting, the additional guide vanes 52 serve to increase the number of guide vanes as a whole, whereby the efficiency of the gas turbine engine 10 is increased.

In FIG. 5, an additional guide vane 52 is arranged between every two load-bearing guide vanes 51, so that the ratio of the number of additional guide vanes 52 to the number of load-bearing guide vanes 51 is 1:1. In alternative embodiments, the ratio may be higher, e.g. 5:1. It is however in principle also possible that the number of additional guide vanes 52 is smaller than the number of load-bearing guide vanes 51.

FIG. 5 also shows that the additional guide vanes 52 have the same aerodynamically active profile and the same size as the load-bearing guide vanes 51. In principle however, it is also possible that the aerodynamically active profile and/or the size of the additional guide vanes 52 differs from those of the load-bearing guide vanes 51.

In the embodiment illustrated here, the additional guide vanes 52 are made of a composite material, in particular a carbon-fiber composite material or a metallic material. In an embodiment not shown here, the additional guide vanes 52 have a metallic coating on the leading edge and/or trailing edge.

FIG. 5 furthermore shows that the additional guide vanes 52, and also the load-bearing guide vanes 51, are connected to an intermediate casing structure 62 which comprises two concentrically arranged rings 62, 63.

FIG. 6 shows a single additional guide vane 52 which, at its radially inner end, has a bolt opening 56 for a bolt connection as part of the connecting means 55.

FIG. 7 shows a derivative of the embodiment of the additional guide vane 52 in FIG. 6. The additional guide vane 52 has guide elements 57 at the radially distal end, which may be inserted in a corresponding receiver 58, e.g. in the engine nacelle 21 (see also FIG. 9).

FIG. 8 shows that the additional guide elements 52 are connected at the radially proximal end to the structural component 60 via an elastic casting compound as a connecting means 55. The casting compound may here also serve as a damping element.

The concept of the additional guide vanes 52 described here allows good access to the fixing points. During maintenance of the gas turbine engine 10, for example individual additional guide vanes 52 may be replaced.

It will be understood that the invention is not limited to the embodiments described above, and various modifications and improvements can be made without departing from the concepts described herein. Any of the features may be used separately or in combination with any other features, unless they are mutually exclusive, and the disclosure extends to and includes all combinations and subcombinations of one or more features which are described here.

### LIST OF REFERENCE SIGNS

9 Main axis of rotation
10 Gas turbine engine, aircraft engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Fan
24 Stationary supporting structure
26 Shaft
27 Connecting shaft
28 Sun gear
30 Gear mechanism
32 Planet gears
34 Planet carrier
36 Linkage
38 Ring gear
40 Linkage
50 Guide vane assembly
51 Load-bearing guide vane
52 Additional guide vane
53 Damping element
55 Connecting means, bolted connection
56 Bolt opening
57 Guide element
58 Receiver for guide element
60 Structural component
61 Intermediate casing structure
62 First ring of intermediate casing structure
62 Second ring of intermediate casing structure
100 Flow guide device
A Core air flow
B Bypass air flow

1. A flow guide device for a gas turbine engine, in particular an aircraft engine, with a fan and a bypass duct downstream of the fan, wherein the bypass duct is arranged radially between an engine nacelle and a core engine of the gas turbine engine,
characterized by
a guide vane assembly with load-bearing guide vanes and additional guide vanes in the bypass duct, wherein
the load-bearing guide vanes are integrally connected to a structural component of the gas turbine engine, and
the additional guide vanes are connected to the structural component via connecting means.

2. The flow guide device according to claim 1, wherein the structural component is connected or coupled to a part of the core engine and/or to a part of the engine nacelle.

3. The flow guide device according to claim 1, wherein the connecting means are configured as screw connections, form-fit connections and/or substance-bonded connections, wherein the connecting means are arranged in particular in a region over which air does not flow.

4. The flow guide device according to claim 1, wherein the number of additional guide vanes is equal to or greater than the number of load-bearing guide vanes.

5. The flow guide device according to claim 4, wherein the ratio of the number of additional guide vanes to load-bearing guide vanes is between 1:2 and 10:1, in particular between 1:1 and 10:1.

6. The flow guide device according to claim 1, wherein during operation, the additional guide vanes bear a smaller structural load than the load-bearing guide vanes.

7. The flow guide device according to claim 1, wherein the additional guide vanes have the same aerodynamically active profile and/or the same size as the load-bearing guide vanes.

8. The flow guide device according to claim 1, wherein the additional guide vanes have a different aerodynamically active profile and/or a different size from the load-bearing guide vanes.

9. The flow guide device according to claim 1, wherein the leading-edge and/or the trailing edge of the additional guide vanes and/or the load-bearing guide vanes is provided with a metal coating.

10. The flow guide device according to claim 1, wherein the additional guide vanes are connected to a mechanical damping element, in particular made of elastic plastic.

11. The flow guide device according to claim 1, wherein the additional guide vanes are made of a composite material, in particular a carbon-fiber composite material, or a metallic material.

12. The flow guide device according to claim 1, wherein the connecting means comprise a bolted connection.

13. The flow guide device according to claim 1, wherein the additional guide vanes are connected to an intermediate casing structure.

14. The flow guide device according to claim 13, wherein the intermediate casing structure comprises two concentrically arranged rings.

15. A gas turbine engine for an aircraft, said gas turbine engine comprising the following:
a core engine comprising a turbine, a compressor, and a core shaft connecting the turbine to the compressor;
a fan, which is positioned upstream of the core engine, wherein the fan comprises a plurality of fan blades; and
a gear mechanism, which can be driven by the core shaft, wherein the fan can be driven by means of the gear mechanism at a lower rotational speed than the core shaft, having a flow guide device according to claim 1.
